(19) United States
(12) Patent Application Publication
(10) Pub. No.: US 2006/0272475 A1
(43) Pub. Date: Dec. 7, 2006

(54) Percussion instrument having membranes no facing each other

(76) Inventor: Claude Gauthier, Dieppe (CA)

Correspondence Address: INVENTARIUM;suite 1607, 4050 Rosemont blvd, Montreal, H1X 1M4, CA

(21) Appl. No.: 11/440,600

(22) Filed: May 24, 2006

Related U.S. Application Data
(60) Provisional application No. 60/685,511, filed on May 31, 2005.

(51) Int. Cl. G10D 13/02

(52) U.S. Cl. 84/411 R

(57) ABSTRACT

A percussion instrument generally comprises a resonance body with at least two ends presenting surfaces not facing each other and a relative angular relationship between each surface of the resonance body, the surface being of course a membrane onto which the percussion is effected.

This application claims priority based on provisional application 60/685,511 filed May 31, 2005

### BACKGROUND OF THE INVENTION

1. Field of the Invention

The invention relates generally to musical instruments but more particularly to percussion instruments having membranes not facing each other.

2. Background of the Invention

Percussion instruments can generally be placed in three categories:
Those having a membrane at one extremity of a resonance box and the other extremity open, such as congas.
Those having a membrane coupled to an enclosed air cavity, such as tablas.
Those having two membranes coupled by an enclosed air cavity, such as bass drums.

In the case of a bass drum, acting upon one membrane will create a sound wave which will be carried by air to the opposite membrane which will transmit, absorb and reflect the energy of the sound wave. Acting on both surfaces creates complex sound waves which cancel each other out or add to each other.

U.S. Pat. No. 4,256,003 describes a multitone percussion instrument capable of producing a variety of drum tones from a single vellum mounted on a shell portion. Tone separation along the expanse of vellum of the drum is effected by providing a rim comprising a compound warp to which the vellum is affixed. In a preferred embodiment, the compound warp comprises a section of a hyperbolic paraboloid defined by straight line boundaries.

U.S. Pat. No. 4,300,437 discloses a drum which has two, axially-separable, generally cylindrical sections, which are open, inwardly, toward each other, each of these two sections having but one playing head, so that the two heads are disposed respectively at the outer ends of the cylindrical assembly. When the open ends of these two basic sections are axially spaced-apart to provide an annular gap between them, the space within said sections communicates with the ambient air, through said gap, substantially uniformly around the periphery of the drum. This construction, with gap, is intended to provide any desired increase in volume, and a great variety of tonal modifications. Means are provided for adjustably varying the size of the gap, or for closing it altogether; whereby the volume, pitch, dynamics, and tonal characteristics of the drum may be varied. This may be done by using adjustable holding means, and/or by using perforate or imperforate cylindrical filler pieces.

U.S. Pat. No. 4,457,202 discloses a percussion drum set having an elongated semi-oval main shell with semi-squared ends enclosing a plurality of sound chambers or resonators in a side-by-side relationship. An auxiliary shell supports the main so that the drum height of the main shell is at one continuous level. A single continuous sound generator or head is adjustably carried across each shell covering the respective sound chambers. Alternately, a plurality of individual drums may be arranged in a row within each of the shells.

U.S. Pat. No. 4,993,304 shows a multi-annular musical drum instrument formed from a plurality of axially aligned permanently connected rings. Each ring formed of a multi-annular ring of laminated plywood, a solid wood or other desireable material. Each ring is non-jointed and undivided in the circumferential direction so as to be formed of a single piece rather than a composite of sections so as to provide uniform vibratory characteristics. One or more of the rings functions as a sounding ring having a greater outer radius than the other shell rings. Such sounding rings receive a connection to a respective drum head. Two rings form outer rings of the cylindrical shell contacting the respective drum heads. Either or both of the two may be rounded to decrease the overtones of the drum head, pointed to increase the overtones of the drum head, or flat so as not to alter the overtones of the drum head.

U.S. Pat. No. 6,242,679 teaches a percussive instrument comprised of two shells, each having open ends. The shells are positioned substantially end to end. Drum heads are positioned at the opposing open ends and between the two shells.

None of the prior art shows percussion instruments having both membranes coupled by air and having their membranes not facing each other, or of a different size or having more than two such membranes.

### SUMMARY OF THE INVENTION

In view of the foregoing disadvantages inherent in the known devices now present in the prior art, the present invention, which will be described subsequently in greater detail, is to provide for a percussion instrument having more than one membrane wherein at least two membranes are not facing each other.

To attain these ends, the present invention generally comprises a resonance body with at least two ends presenting surfaces not facing each other and a relative angular relationship between each surface of the resonance body, the surface being of course a membrane onto which the percussion is effected.

In a variation of the embodiment, the resonance body is subdivided into a plurality of chambers.

In yet another variation, the resonance body is <<U>> shaped and has one end that is open.

In still another variation, the <<U>> shaped resonance body has both ends closed.

The chambers can be the same size, that is have the same interior volume or they can each have different interior volumes.

In a variation applicable to all aforementioned variations, at least one window is made through the resonance body and is openable and closeable to variable degrees by way of a cover which is actuated by an actuating means.

With the help of mathematical formulas the proper volumes can be calculated to provide the desired resonance using an Helmholtz resonator approximation for the air inside the drum cavity and a two-dimensional Cartesian coordinate system to describe the motion of each membrane defined as mass.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view.

FIG. 2 Top see through view.

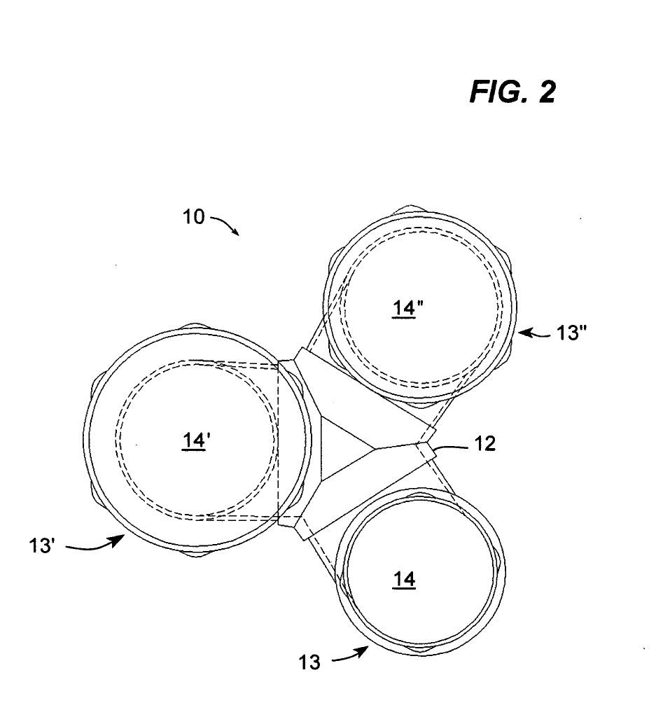

FIG. 3 Side see through view.

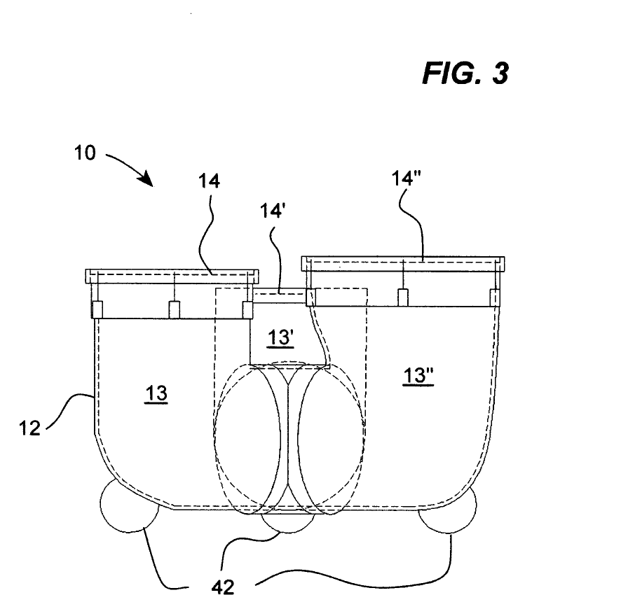

FIG. 4 Cutaway side view.

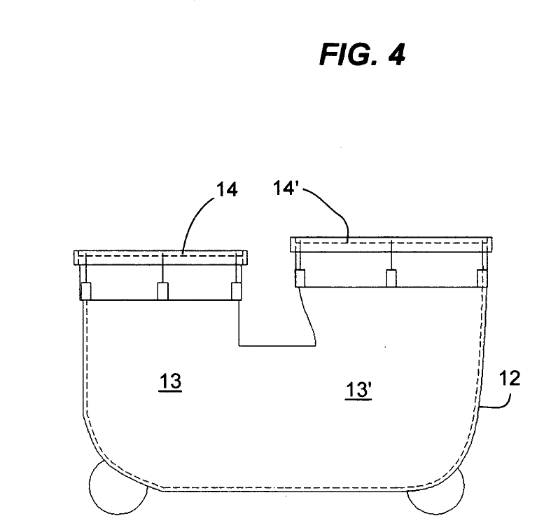

FIGS. 5ab Perspective views of alternate embodiments.

FIGS. 6a-c Side view with detailed side views of the cover actuating means used for shutting the window and the window cover in different positions.

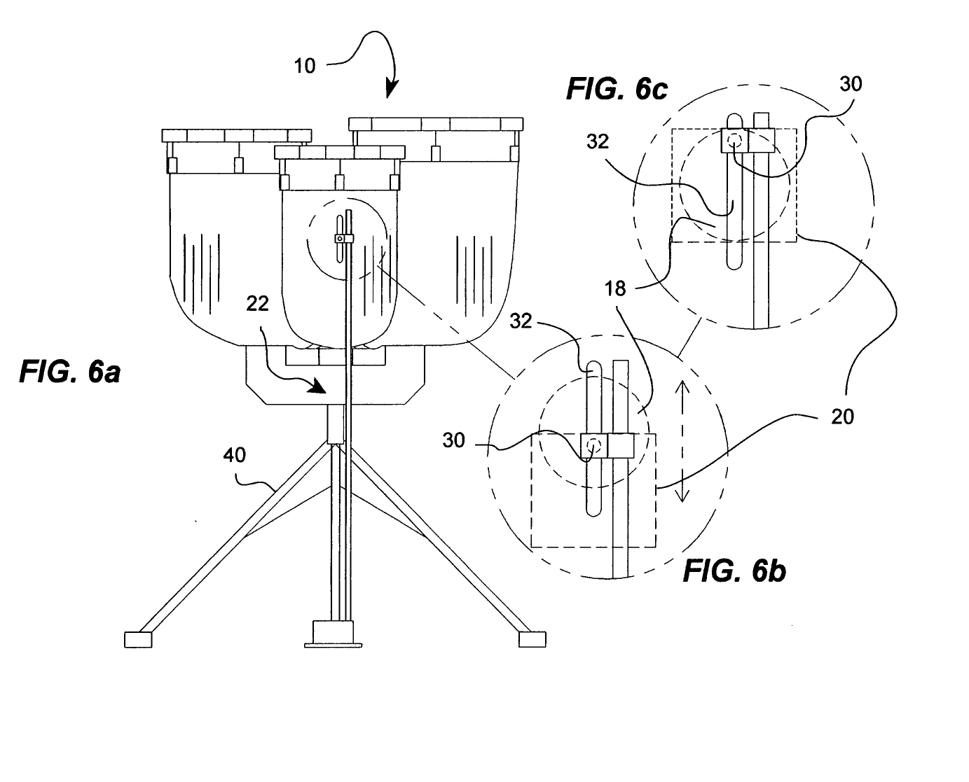

### DETAILED DESCRIPTION OF THE PREFERRED EMBODIMENT

A percussion instrument (10) has a resonance body (12) and at least one membrane (14). In its simplest expression, the resonance body (12) is <<U>> shaped and has one end (16) that is open, while a second variation has both ends (16, 16′) closed.

Generally, all features found on typical percussion instruments such as adjustment means for tensioning the membrane (14), tripod (40) or footings (42) are also found on this percussion instrument (10) and need not be discussed here.

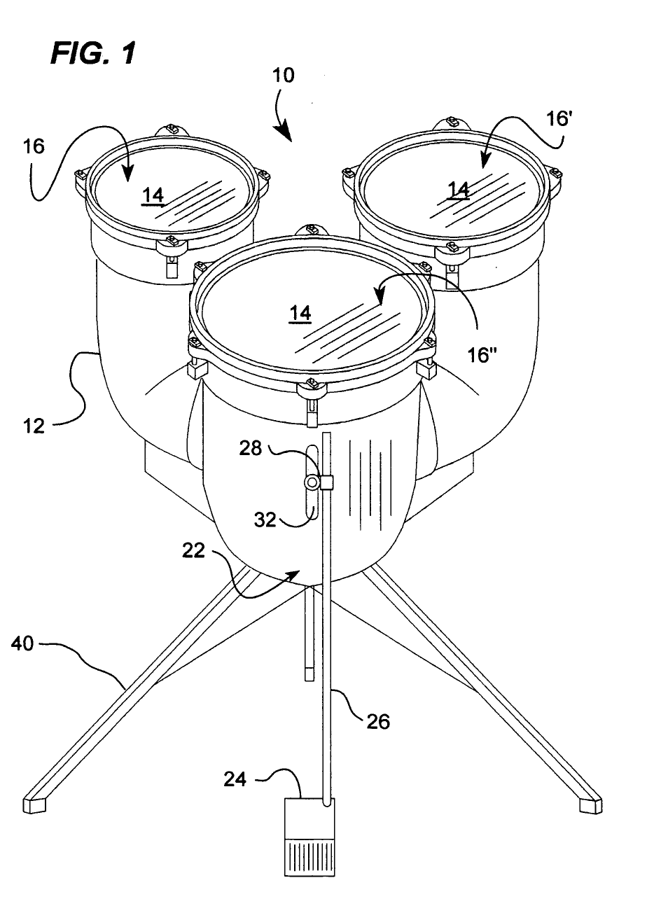

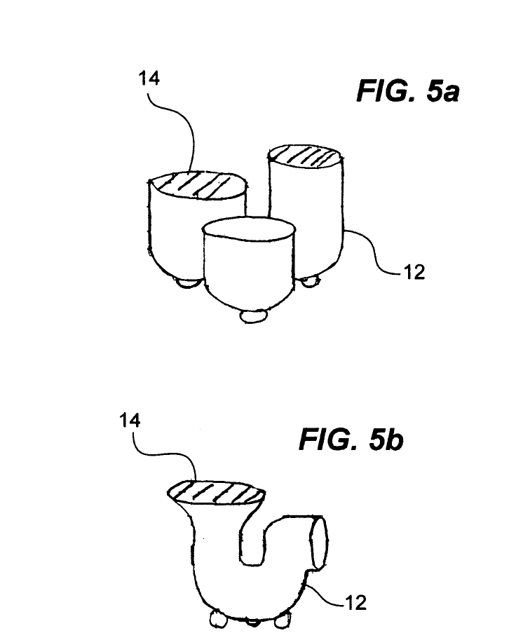

A typical embodiment, such as seen in FIG. 1, has three ends (16, 16′, 16″), each representing the position of a chamber (13, 13′, 13″), each chamber (13, 13′, 13″) being a subset of the resonance body (12). Each chamber (13, 13′, 13″) has an angular relationship with adjoining chambers (13, 13′, 13″) so that membranes (14) are not directly facing each others and each chamber can have an internal volume that can be equal or non equal in relation to the other chambers (13, 13′, 13″). A similar three chamber (13, 13′, 13″) embodiment could have a non “U” shape configuration such as seen in FIG. 5b for example (but with 3 chambers instead of the two illustrated).

Several variations are possible such as having one end (16) open while the other two ends (16′, 16″) are closed with a membrane (14). Another variation, such as shown in FIG. 1 has all ends (16, 16′, 16″) closed.

When interacting with one membrane (14), a sound wave will travel into two or more chambers (13, 13′, 13″) and interact with either an open end (16, 16′, 16″) or a membrane (14), or a plurality of membranes (14, 14′, 14″). The interaction of the several sound waves created causes complex patterns.

In order to provide the desired resonance, a set of rules has to be applied during the construction of the percussion instrument (10). These rules are based on mathematical equations used in defining a mode.

Since the fundamental mode, i.e. the (0,1) mode, is the most energetic of the modes of any homogeneous circular membrane, a good description of the sounds produced by this kind of drums can be obtained from the analysis of this mode. In the following, we shall first present a mechanical model which describes the small amplitude (0,1) mode motions.

To simplify the presentation, we shall limit ourself to the case of a drum with three membranes. The general case is similar. We use the Helmholtz resonator approximation for the air inside the drum cavity. According to this approximation, the pressure is uniform throughout the enclosed volume at each instant t.

To express the triangular configuration of the drum, we consider three rigid supports placed as the triangular shape formed by the centres of the three membranes of the drum. Each of the three membranes is represented by a mass mᵢ and a massless spring with stiffness aᵢ, i=1; 2; 3. One extremity of the spring is attached to a rigid support, while the other one is attached to the mass. Each mass is also connected to the two other masses through a couple of springs which are forced to stay parallel, between each of the masses and the model centre, with three driving wheels placed near this centre. Each of these springs is itself formed of two springs of the same length attached one at the end of the other by a piece of inextensible string. Both of the parallel springs between the mass mᵢ and the model centre are assumed to have a stiffness bᵢ/2. We assume that all masses and springs move without friction, and the movements are of small amplitude.

To describe the motion of each mass, we use a two-dimensional Cartesian coordinate system whose origin is located at the centre of mass of m₁ at rest, and the x-axis coincides with the line along which m₁ moves. The equilibrium position of the mass mᵢ will be denoted by xᵢ₀ and its position at time t by xᵢ(t). It is then convenient to describe the motion of the mass mᵢ in terms of the displacement uᵢ(t)=xᵢ(t)−xᵢ₀, i=1; 2; 3. The motion of the three masses is described by the system of coupled differential equations

$${m}_{1} {\ddot{u}}_{1} = - ( {a}_{1} + {b}_{1} ) {u}_{1} + \frac{1}{2} {b}_{2} {u}_{2} + \frac{1}{2} {b}_{3} {u}_{3} \\ {m}_{2} {\ddot{u}}_{2} = \frac{1}{2} {b}_{1} {u}_{1} - ( {a}_{2} + {b}_{2} ) {u}_{2} - \frac{1}{2} {b}_{3} {u}_{3} \\ {m}_{3} {\ddot{u}}_{3} = \frac{1}{2} {b}_{1} {u}_{1} - \frac{1}{2} {b}_{2} {u}_{2} - ( {a}_{3} + {b}_{3} ) {u}_{3} ; \qquad ( 1 )$$

where each dot represents differentiation with respect to t.

It is known that masses whose motions are described by equations as those of this system may have oscillations with certain natural angular frequencies. To determine these frequencies, we look for a solution of (1) such as
uᵢ(t)=Aᵢ cos wt, i=1, 2, 3 (2)
where the Aᵢ are constants and w is one of natural angular frequencies of the three-mass system. Substitution of (2) into (1) leads to the system of homogeneous linear equations

$$( {a}_{1} + {b}_{1} - {m}_{1} {w}^{2} ) {A}_{1} - \frac{1}{2} {b}_{2} {A}_{2} - \frac{1}{2} {b}_{3} {A}_{3} = 0 \\ - \frac{1}{2} {b}_{1} {A}_{1} + ( {a}_{2} + {b}_{2} - {m}_{2} {w}^{2} ) {A}_{2} + \frac{1}{2} {b}_{3} {A}_{3} = 0 \\ - \frac{1}{2} {b}_{1} {A}_{1} + \frac{1}{2} {b}_{2} {A}_{2} + ( {a}_{3} + {b}_{3} - {m}_{3} {w}^{2} ) {A}_{3} = 0. \qquad ( 3 )$$

The system of equations (3) will have a non-trivial solution if and only if its determinant vanishes. This condition determines the natural frequencies of the three-mass system.

To give an example, we determine the motions of three masses m corresponding to three identical membranes. The system of differential equations (1) can then be written
Ü=AU, (4)
where U=(u₁, u₂, u₃)^{T} and

$$A = ( \begin{matrix}- \frac{a + b}{m} & \frac{b}{2 m} & \frac{b}{2 m} \\ \frac{b}{2 m} & - \frac{a + b}{m} & - \frac{b}{2 m} \\ \frac{b}{2 m} & - \frac{b}{2 m} & - \frac{a + b}{m}\end{matrix} ) .$$

The solution of (4) is
u₁(t)=(A₁+B₁) cos w₁t+(A₂+B₂) sin w₁t+C₁ cos w₁₁t+C₂ sin w₁₁t
u₂(t)=A₁ cos w₁t+A₂ sin w₁t−C₁ cos w₁₁t−C₂ sin w₁₁t
u₃(t)=B₁ cos w₁t+B₂ sin w₁t−C₁ cos w₁₁t−C₂ sin w₁₁t
where

$${w}_{1} = \sqrt{( a + \frac{b}{2} ) / m} and {w}_{11} = \sqrt{( a + 2 b ) / m} .$$

If the motions of the membranes result from an external impulse I delivered instantaneously at the centre of the first membrane, we obtain

$${u}_{1} ( t ) = \frac{I}{3 m {w}_{1}} ( 2 sin {w}_{1} t + sin {w}_{11} t )$$

$${u}_{2} ( t ) = \frac{I}{3 m {w}_{1}} ( sin {w}_{1} t - sin {w}_{11} t )$$

$${u}_{3} ( t ) = \frac{I}{3 m {w}_{1}} ( sin {w}_{1} t - sin {w}_{11} t ) .$$

Further variations in sound texturing can be obtained through one or more windows (18) made through the resonance body (12) and which can be open and closed to variable degrees by way of a cover (20) movable from an open to a closed position, and all intermediate degrees of aperture in between, by way of all intermediate degrees of aperture by way of a cover actuating means (22). In this example, the cover actuating means (22) comprises a pedal (24), a rod (26), an adjustable connector (28) to interface between the rod (26) and an inner rod (30) located inside the resonance body (12) and which reaches across from one side of the resonance body (12) to the other side so as to directly connect to the cover (20). The inner rod (30) passes through a slit (32) made throuh the resonance body (12) in order to connect with the adjustable connector (28). Variations of the adjustable connector (28), the pedal (24) and the rod (26) are known in the art and need no further description.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A percussion instrument comprising:
a resonance body with at least two ends presenting surfaces not facing each other;
a relative angular relationship between each said surface of said resonance body;
said surface being a membrane.

2. A percussion instrument as in claim 1 wherein:
said resonance body being subdivided into a plurality of chambers.

3. A percussion instrument as in claim 1 wherein:
said resonance body being <<U>> shaped and having one end that is open.

4. A percussion instrument as in claim 1 wherein:
said resonance body being <<U>> shaped and having both ends closed.

5. A percussion instrument as in claim 2 wherein:
Each chamber of said plurality of chambers having different interior volumes.

6. A percussion instrument as in claim 1 having the following method of fabrication:
a set of rules to provide the desired resonance using an Helmholtz resonator approximation for the air inside the drum cavity and a two-dimensional Cartesian coordinate system to describe the motion of each membrane defined as mass.

7. A percussion instrument as in claim 1 wherein:
at least one window made through said resonance body;
said window being openable and closeable to variable degrees by way of a cover;
said cover being movable from an open to a closed position, and all intermediate degrees of aperture in between, by way of a cover actuating means.

8. A percussion instrument as in claim 7 wherein:
said cover actuating means having a pedal, a rod, and an adjustable connector to interface between said rod and an inner rod located inside said resonance body and which reaches across from one side of said resonance body to the other side so as to directly connect to said cover;
said inner rod passing through a slit made throuh said resonance body so as to connect with said adjustable connector.
